(19) United States
(12) Patent Application Publication
(10) Pub. No.: US 2007/0080946 A1
(43) Pub. Date: Apr. 12, 2007

(54) Portable electronic device including trackball unit and associated methods

(75) Inventors: Steven H. Fyke, Waterloo (CA); John W. Wynen, Conestoga (CA); Kevin H. Orr, Elmira (CA); Vahid Moosavi, Kitchener (CA)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Research In Motion Limited, Waterloo (CA)

(21) Appl. No.: 11/246,465

(22) Filed: Oct. 7, 2005

(51) Int. Cl. G09G 5/08

(52) U.S. Cl. 345/167

(57) ABSTRACT

The portable electronic device, such as a cell phone or wireless email device, includes a portable housing, a battery carried by the portable housing, and a trackball carried by the portable housing for permitting user pointing. The trackball includes a ball, at least one rotation sensor cooperating with the ball, and a power control switch responsive to displacement of the ball for selectively powering the at least one rotation sensor from the battery. The electronic device conserves power by selectively powering the trackball unit for user pointing and selecting.

### FIELD OF THE INVENTION

The invention relates to the field of portable electronic devices, and, more particularly, to portable electronic devices including a trackball unit and related methods.

### BACKGROUND OF THE INVENTION

An electronic device may conserve power by using a power management scheme that switches various system components to a low-power or no-power state based upon user settings and/or user input. Such a low-power state may be referred to as a standby, sleep, or hibernation state. The electronic device or components thereof may transition to an active or high-power state from the low-power state when something triggers the electronic device or components to begin a wake-up routine.

One way to trigger the wake-up routine for the electronic device is by using programmable state transitions as is disclosed by U.S. Published Application No. 2003/0145242 to Derocher et al. The electronic device includes a clock that generates a signal in response to a programmed time of day to initialize a wake-up routine for the electronic device. Similarly, U.S. Pat. No. 5,530,879 to Crump et al. also discloses a system that initiates a wake-up routine based on a signal from a timer, as well as from a signal received from a switch or modem connected to the system.

U.S. Published Application No. 2003/0159076 to Delisle et al. also discloses an electronic device using switches to initialize a wake-up routine. The electronic device includes a keyboard controller that is connected to power, standby, lid open/close, and battery insertion/removal switches. An activation signal sent by any of the foregoing switches causes the keyboard controller to initiate a wake-up routine for the electronic device.

Another way to initiate a wake-up routine is for an electronic device to be responsive to a pointing device. U.S. Pat. No. 5,990,868 to Frederick discloses a pointing device for an electronic device that includes a power management system connected to a trackball. The power management system continually monitors the trackball for activity and adjusts the power level of the trackball according to the amount of time it has been idle. U.S. Pat. No. 5,974,558 to Cortopassi et al. discloses an electronic device having a digitizer panel that uses a passive stylus as a pointing device. The electronic device may go into a low-power state after a predetermined period of inactivity, and the stylus touching the digitizer panel initializes a wake-up routine.

Power management is especially important for a portable electronic device, like a cell phone and wireless email device, whose operation may be limited by the operational charge of its battery.

### BRIEF DESCRIPTION OF THE DRAWINGS

FIG. 1 is a schematic diagram of a portable electronic device in accordance with the invention.

FIG. 2 is a more detailed exploded view of the trackball of the portable electronic device of FIG. 1.

FIG. 3 is a top view of an embodiment of the trackball of FIG. 2.

FIG. 4 is a cross-sectional view of the trackball of FIG. 3.

FIG. 5 is a cross-sectional view of another embodiment of the trackball of FIG. 2.

FIG. 6 is a more detailed schematic diagram, partially in section, of a portion of the portable electronic device as shown in FIG. 1.

FIG. 7 is a non-random pattern pulse timing diagram as may be generated by the pointing device of the portable electronic device of FIG. 1.

FIG. 8 is a random pattern pulse timing diagram as may be generated by the pointing device of the portable electronic device of FIG. 1.

FIG. 9 is a random pattern pulse timing diagram as may be generated by the pointing device of the portable electronic device of FIG. 1.

FIG. 10 is a flow chart illustrating a method according to the invention.

FIG. 11 is a more detailed schematic block diagram of an alternate embodiment of a portable electronic device according to the invention.

### DETAILED DESCRIPTION OF THE PREFERRED EMBODIMENTS

The device will now be described more fully hereinafter with reference to the accompanying drawings, in which preferred embodiments are shown. This device may, however, be embodied in many different forms and should not be construed as limited to the embodiments set forth herein. Rather, these embodiments are provided so that this disclosure will be thorough and complete, and will fully convey the scope to those skilled in the art. Like numbers refer to like elements throughout.

In general, the device can be summarized as follows. In view of the foregoing background, it is therefore an object to provide an electronic device that conserves power by selectively powering a trackball unit for user pointing and selecting.

This and other objects, features, and advantages are provided by a portable electronic device, such as a cell phone or wireless email device comprising a portable housing, a battery carried by the portable housing, and a trackball carried by the portable housing for permitting user pointing. The trackball may include a frame, a ball mounted by the frame to permit user rotation and displacement of the ball, at least one rotation sensor cooperating with the ball, and a power control switch responsive to displacement of the ball for selectively powering the at least one rotation sensor from the battery.

A circuit board may be carried by the portable housing and mounting the trackball, and the power control switch may be operatively connected between the ball and the circuit board. The power control switch may comprise at least one electrically conductive spring for biasing the ball outwardly from the circuit board. The at least one electrically conductive spring may comprise a first end electrically connected to the circuit board, and a second end being movable and defining a first contact of the power control switch.

A selection switch may be included that is also responsive to displacement of the ball for permitting user selection, and the selection switch may comprise a deformable electrically conductive dome carried by the circuit board and defining a second contact of the power control switch. The at least one electrically conductive spring may comprise a pair of electrically conductive springs, each having first ends electrically connected to the circuit board and second ends being movable together and defining first and second contacts for the power control switch. The at least one electrically conductive spring may comprise a cantilevered leaf spring.

The at least one rotation sensor may comprise at least one magnetic roller and a Hall sensor associated therewith. For example, the at least one rotation sensor may comprise four magnetic rollers and a respective Hall sensor associated with each magnetic roller.

Electronic circuitry may be carried by the portable housing and connected to the battery and the trackball. The electronic circuitry may be switchable from a sleep mode to an active mode based upon operation of the trackball in a non-random pattern and not switching from the sleep mode to the active mode based upon operation of the trackball in a random pattern. The non-random pattern corresponds to manipulation of the pointing device at a uniform speed and in a uniform direction. The trackball may be exposed on an outer surface of the portable housing.

A method aspect is directed to power management for a portable electronic device comprising a portable housing, a battery and trackball carried by the portable housing for permitting user pointing. The trackball includes a frame, a ball mounted by the frame to permit user rotation and displacement of the ball, and at least one rotation sensor cooperating with the ball. The method includes selectively powering the at least one rotation sensor from the battery in response to displacement of the ball.

The portable electronic device may further comprise a circuit board carried by the portable housing and mounting the trackball, and wherein selectively powering comprises providing a power control switch operatively connected between the ball and the circuit board. Providing a power control switch may comprise providing at least one electrically conductive spring for biasing the ball outwardly from the circuit board.

The at least one electrically conductive spring may comprise a first end electrically connected to the circuit board, and a second end being movable and defining a first contact of the power control switch. The at least one rotation sensor may comprise at least one magnetic roller and a Hall sensor associated therewith, for example, the at least one rotation sensor may comprise four magnetic rollers and a respective Hall sensor associated with each magnetic roller.

The portable electronic device may further comprise electronic circuitry carried by the portable housing and connected to the battery and the trackball, and the method may further comprise switching the electronic circuitry from a sleep mode to an active mode based upon operation of the pointing device in a non-random pattern, and not switching the electronic circuitry from the sleep mode to the active mode based upon operation of the pointing device in a random pattern.

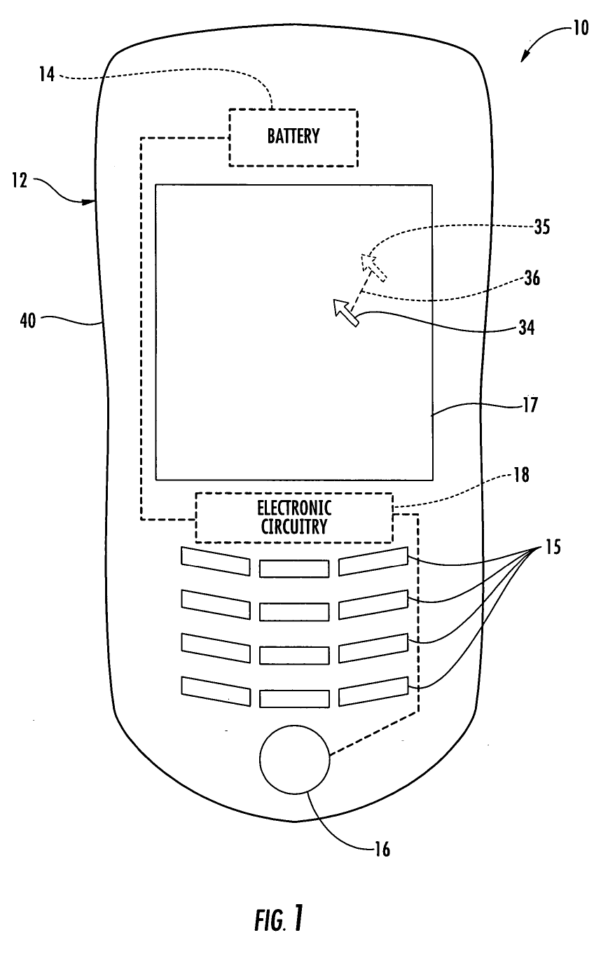

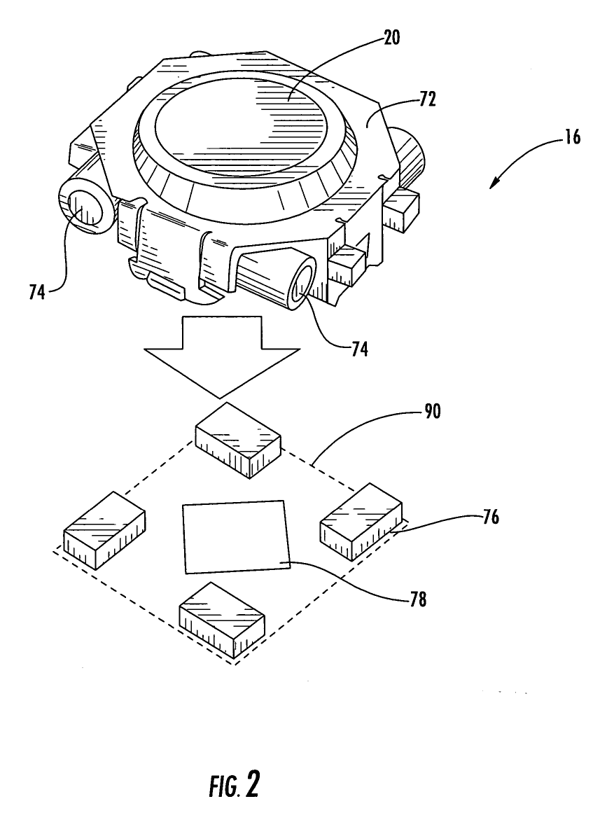

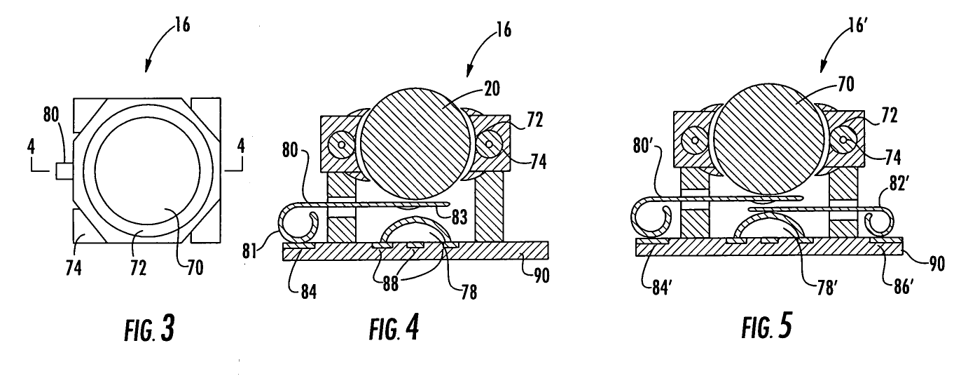

Referring initially to FIGS. 1-4, a portable electronic device 10 is now described. The portable electronic device 10 illustratively includes a portable housing 12, and a battery 14 and pointing device 16 carried by the portable housing. The pointing device 16 is a trackball type input device or jog ball, and will be referred to hereinafter simply as a trackball 16.

The portable electronic device 10 further includes electronic circuitry 18 carried by the portable housing 12 and connected to the battery 14 and the trackball 16 as will be appreciated by those skilled in the art. The portable electronic device 10 also illustratively includes a display screen 17 and input keys 15. Both the display screen 17 and input keys 15 are connected to the electronic circuitry 18 as will be appreciated by those of skill in the art. The portable electronic device 10 may be in the form of a cell phone, personal digital assistant (PDA), wireless email device, pager, or the like, for example.

The trackball 16 may include a frame 72, a ball 70 mounted by the frame to permit user rotation and displacement of the ball, at least one rotation sensor 74, 76 cooperating with the ball, and a power control switch 78, 80, 84, 88 responsive to displacement of the ball 70 for selectively powering the at least one rotation sensor 74, 76 from the battery.

A circuit board 90 may be carried by the portable housing 12 and mounting the trackball 16, and the power control switch may be operatively connected between the ball 70 and the circuit board. The power control switch may comprise at least one electrically conductive spring 80 for biasing the ball 70 outwardly from the circuit board 90. The at least one electrically conductive spring 80 may comprise a first end 81 electrically connected via contact 84 to the circuit board 90, and a second end 83 being movable and defining a first contact of the power control switch.

A selection switch 78, 88 may be included that is also responsive to displacement of the ball 16 for permitting user selection, and the selection switch may comprise a deformable electrically conductive dome 78 and associated contacts 88 carried by the circuit board 90 and defining a second contact of the power control switch.

In another embodiment of the trackball 16′, the at least one electrically conductive spring may comprise a pair of electrically conductive springs 80′, 82′, illustratively shown in FIG. 5, each having first ends electrically connected to the circuit board 90, via contacts 84′, 86′, and second ends being movable together and defining first and second contacts for the power control switch. As shown in the figures, each of the electrically conductive springs 80′, 82′ may comprise a cantilevered leaf spring. In this embodiment, the power control switch is defined by the electrically conductive springs 8040 , 82′ and contacts 84′, 86′.

As illustrated, the at least one rotation sensor 74, 76 may comprise at least one magnetic roller 74 and a Hall sensor 76 associated therewith. The operation of such a magnetic roller 74 and a Hall sensor 76 is within the knowledge of the skilled artisan. The at least one rotation sensor 74, 76 may comprise four magnetic rollers 74 and a respective Hall sensor 76 associated with each magnetic roller, as illustrated.

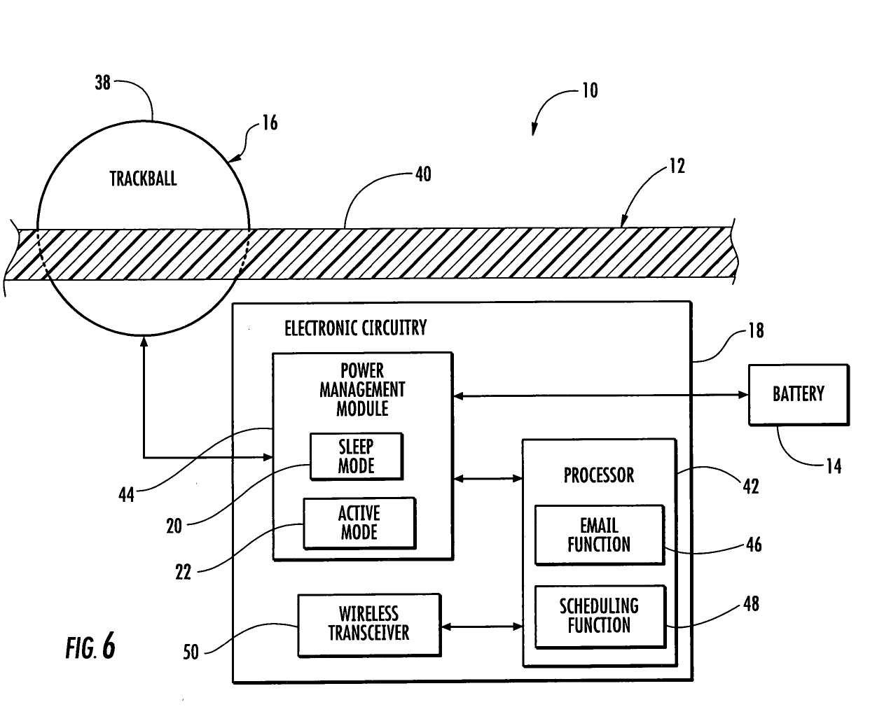

The hall sensors or Hall-ICs 76 used for trackball movement detection have a significant quiescent current when in standby mode. Typically four hall ICs 76, one for each direction (up, down, left, right), are used to track movement of the ball 70. The present device and method addresses the need to reduce the power consumed when the trackball 16 is not in use to extend battery life. By powering off the hall ICs 76 when the user does not touch the trackball 16, the power usage is reduced. The use of the power control switch 78/80/84/88 or 80′/82′/84′/86′ triggers (preferably via the power management module 44 discussed in further detail below with reference to FIG. 6) the processor 42 to wake-up, and thereby provide power to the hall ICs 76, when the trackball 16 is first moved. The switch preferably uses very light activation force. The Power Management Module 44, may enable all or just some (e.g. Up/Down direction) of the Hall ICs 76 to be able to detect the trackball rolling speed and direction to thereby decide if it should wake up the processor 42.

To further improve current consumption during operation of the trackball 16, when the trackball moves in one direction, the respective Hall IC 76 in the opposite direction can be turned off. Power would be controlled to each of the Hall ICs via use of a transistor based type of switch such as a FET. This additional functionality may reduce the power usage of the Hall ICs 76 by 50%. As a variation to improve current consumption, instead of powering all rotation sensors, only the up/down sensors or the left/right sensors may be powered, and/or power between the up/down and the left/right sensors may be cycled while checking for a non-random pattern to initiate wake-up.

An additional aspect of the device and method, which may be used in connection with the trackball power management feature discussed above, will now be described. The electronic circuitry 18 may switch from a sleep mode 20 to an active mode 22 based upon operation of the pointing device 16 in a non-random pattern, and does not switch from the sleep mode to the active mode based upon operation of the pointing device in a random pattern. Accordingly, the portable electronic device 10 may conserve power by discriminating between intentional and inadvertent initialization of the wake-up routine.

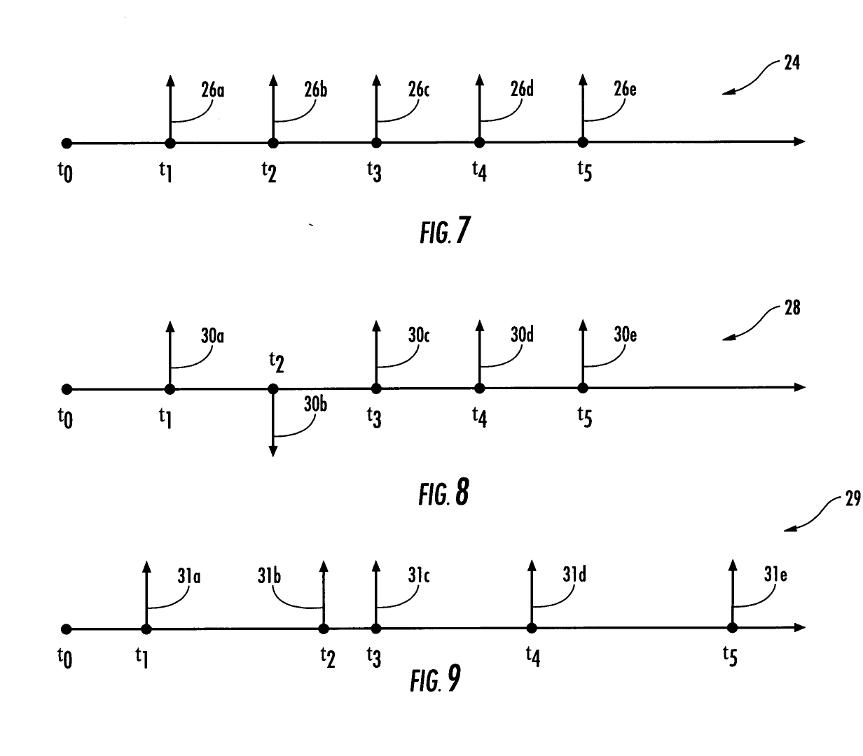

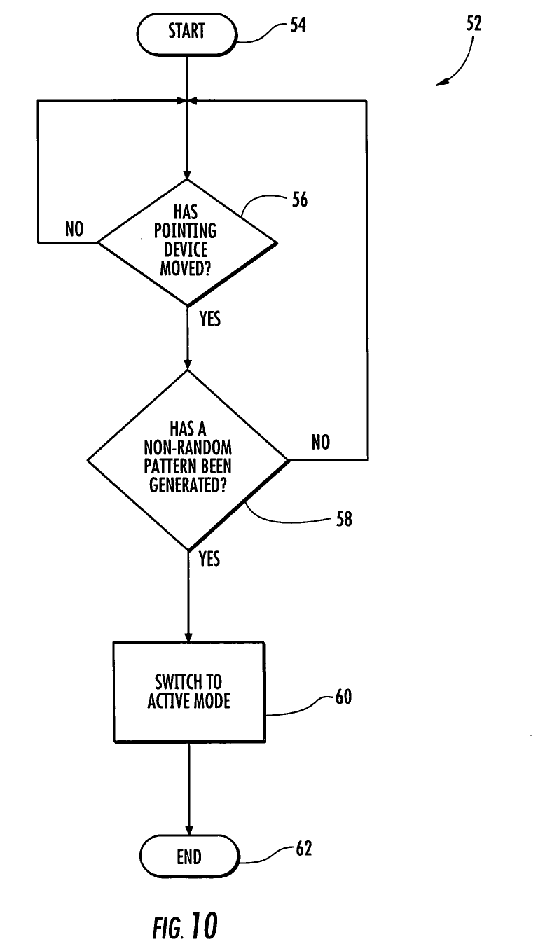

Referring now additionally to FIGS. 7-9, exemplary graphs illustrate exemplary time/direction pulses 26a-26e for the non-random pattern 24 and the time/direction pulses 30a-30e and 31a-31e for the random patterns 28 and 29. The time/direction pulses 26a-26e, 30a-30e, and 31a-31e are generated by the electronic circuitry 18 receiving signals from the manipulation of the pointing device 16 at times t₀-t₅ as will be appreciated by those of skill in the art. The exemplary graphs are illustrated in one axis for ease of understanding, although the portable electronic device 10 may generate time/direction pulses 26a-26e, 30a-30e, and 31a-31e in more than one axis.

The time/direction pulses 26a-26e, 30a-30e, and 31a-31e received by the electronic circuitry 18 may be a series of light pulses. For example, a traditional opto-mechanical trackball system uses two different colored lights, one light sensor, and an encoder wheel connected to an axis that engages the trackball to generate a series of light pulses used by electronic circuitry and/or processor to determine the speed and direction of the trackball as will be appreciated by those of skill in the art. Alternately, the pulses may be generated by other sensor systems such as a Hall effect sensor working in combination with a magnet.

The spacing between each time/direction pulse 26a-26e, 30a-30e, and 31a-31e represents the speed at which the pointing device 16 is traveling between two adjacent times t₀-t₅, and the arrow on each time/direction pulse 26a-26e, 30a-30e, and 31a-31e represents the direction that the pointing device 16 is traveling at a given time t₀-t₅. For instance, the non-random pattern 24 corresponds to manipulation of the pointing device 16 at a uniform speed and in a uniform direction.

The manipulation may involve a user moving the pointing device 16 in a specific direction. If the portable electronic device 10 were in an active mode, an action may move the pointer 34 along the dashed path 36 to a new position as resented by the dashed pointer 35 (FIG. 1). The non-random pattern 24 may further correspond to manipulation of the pointing device 16 for at least a threshold distance as will be appreciated by those of skill in the art.

A random pattern 28 may correspond to manipulation of the pointing device 16 at a uniform speed, but in a non-uniform direction as indicated by the time/direction pulse 30b pointing in a different direction than the other time/direction pulses 30a, 30c, 30d, and 30e for example. Alternately, the random pattern 29 may correspond to manipulation of the pointing device 16 at a non-uniform speed, but in a uniform direction as indicated by the difference in spacing between time/direction pulse 31a and 31b. Additionally, the random pattern may include other time/direction pulse combinations.

Returning again to FIGS. 1 and 6, the threshold distance may correspond to rotation of the trackball for at least one hundred degrees, for example, as will be appreciated by those of skill in the art. The pointing device 16 may be exposed on an outer surface 40 of the housing 12 and thus be susceptible to contact with a user's pocket, for example.

The electronic circuitry 18 illustratively comprises a processor 42 and a power management module 44 cooperating with the processor as will be appreciated by those of skill in the art. The processor 42 may perform email functions 46 and/or scheduling functions 48, for example. The electronic circuitry may also comprise a wireless transceiver 50.

A method aspect is directed to power management for the portable electronic device 10 comprising a portable housing 12, a battery 14 and trackball 16 carried by the portable housing for permitting user pointing. The trackball 16 includes a frame 72, a ball 70 mounted by the frame to permit user rotation and displacement of the ball, and at least one rotation sensor 74, 76 cooperating with the ball. The method includes selectively powering the at least one rotation sensor 74, 76 from the battery 14 in response to displacement of the ball 70.

Another method aspect is for the power management of a portable electronic device 10 which may be used in connection with the first method aspect described above. This method aspect is now described with reference to the flowchart 52 of FIG. 10. As discussed, the portable electronic device 10 may include a portable housing 12, a battery 14 and a pointing device 16 carried by the portable housing, and electronic circuitry 18 carried by the portable housing and connected to the battery and the pointing device.

The method starts at Block 54 and begins with the electronic circuitry 18 checking to see if the pointing device 16 has moved at Block 56. The portable electronic device 10 is considered as being in the sleep or low power mode initially. It may enter the sleep mode by user selection or based on a period of inactivity, for example. If the pointing device 16 has not moved, the electronic circuitry 18 continues to monitor the pointing device. If the pointing device 16 has moved, the electronic circuitry 18 determines if a non-random pattern 24 has been generated at Block 58. If a non-random pattern 24 has been generated, the electronic circuitry 18 switches from a sleep mode 20 to an active mode 22 based upon operation of the pointing device 16 in a non-random pattern at Block 60. If a non-random pattern 24 has not been generated, the electronic circuitry 18 does not switch from the sleep mode 20 to the active mode 22 based upon operation of the pointing device 16 in the random pattern 28. The method ends at Block 62.

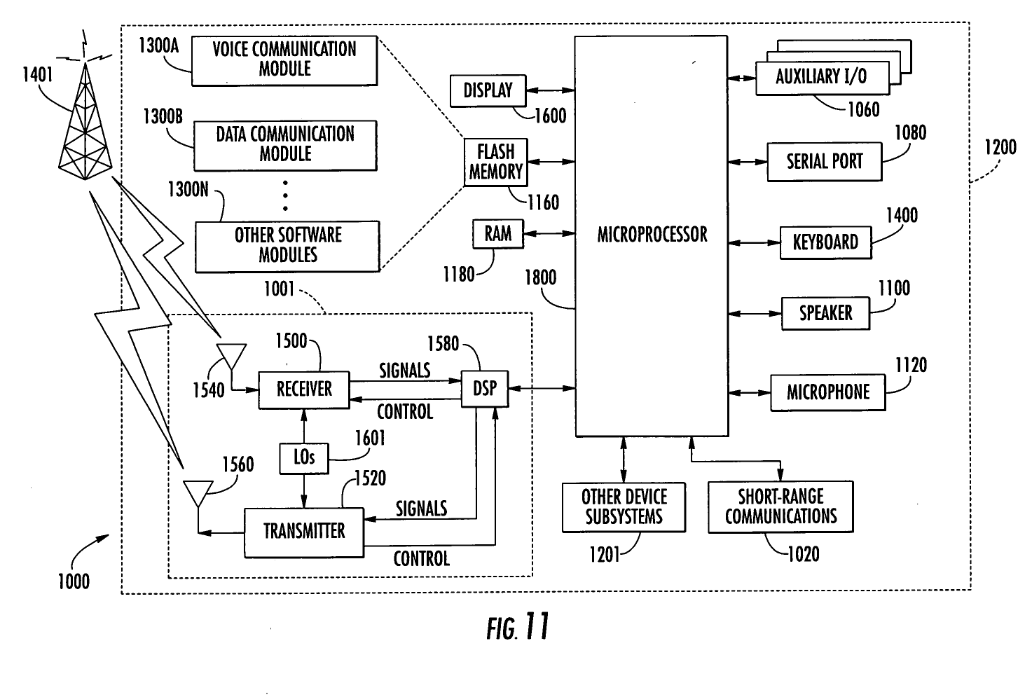

Another example of a handheld mobile wireless communications device 1000 that may be used in accordance the present device and method is further described with reference to FIG. 11. The device 1000 includes a housing 1200, a keyboard 1400 and an output device 1600. The output device shown is a display 1600, which is preferably a full graphic LCD. Other types of output devices may alternatively be utilized. A processing device 1800 is contained within the housing 1200 and is coupled between the keyboard 1400 and the display 1600. The processing device 1800 controls the operation of the display 1600, as well as the overall operation of the mobile device 1000, in response to actuation of keys on the keyboard 1400 by the user.

The housing 1200 may be elongated vertically, or may take on other sizes and shapes (including clamshell housing structures). The keyboard may include a mode selection key, or other hardware or software for switching between text entry and telephony entry.

In addition to the processing device 1800, other parts of the mobile device 1000 are shown schematically in FIG. 11. These include a communications subsystem 1001; a short-range communications subsystem 1020; the keyboard 1400 and the display 1600, along with other input/output devices 1060, 1080, 1100 and 1120; as well as memory devices 1160, 1180 and various other device subsystems 1201. The mobile device 1000 is preferably a two-way RF communications device having voice and data communications capabilities. In addition, the mobile device 1000 preferably has the capability to communicate with other computer systems via the Internet.

Operating system software executed by the processing device 1800 is preferably stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM is preferably capable of organizing and managing data items, such as e-mail, calendar events, voice mails, appointments, and task items. The PIM application is also preferably capable of sending and receiving data items via a wireless network 1401. Preferably, the PIM data items are seamlessly integrated, synchronized and updated via the wireless network 1401 with the device user's corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, PCS, GSM, etc. Other types of data and voice networks, both separate and integrated, may also be utilized with the mobile device 1000.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore requires a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device user may also compose data items, such as e-mail messages, using the keyboard 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, or a Bluetooth communications module to provide for communication with similarly-enabled systems and devices.

Many modifications and other embodiments will come to the mind of one skilled in the art having the benefit of the teachings presented in the foregoing descriptions and the associated drawings. Therefore, it is understood that the device and method is not to be limited to the specific embodiments disclosed, and that other modifications and embodiments are intended to be included within the scope of the appended claims.

That which is claimed is:

1. A portable electronic device comprising:
a portable housing;
a battery carried by said portable housing; and
a trackball carried by said portable housing for permitting user pointing and comprising
a frame,
a ball mounted by said frame to permit user rotation and displacement of said ball,
at least one rotation sensor cooperating with said ball, and
a power control switch responsive to displacement of said ball for selectively powering said at least one rotation sensor from said battery.

2. The portable electronic device according to claim 1 further comprising a circuit board carried by said portable housing and mounting said trackball; and wherein said power control switch is operatively connected between said ball and said circuit board.

3. The portable electronic device according to claim 2 wherein said power control switch comprises at least one electrically conductive spring for biasing said ball outwardly from said circuit board.

4. The portable electronic device according to claim 3 wherein said at least one electrically conductive spring comprises a first end electrically connected to said circuit board, and a second end being movable and defining a first contact of said power control switch.

5. The portable electronic device according to claim 4 further comprising a selection switch also responsive to displacement of said ball for permitting user selection; and wherein said selection switch comprises a deformable electrically conductive dome carried by said circuit board and defining a second contact of said power control switch.

6. The portable electronic device according to claim 3 wherein said at least one electrically conductive spring comprises a pair of electrically conductive springs, each having first ends electrically connected to said circuit board and second ends being movable together and defining first and second contacts for said power control switch.

7. The portable electronic device according to claim 3 wherein said at least one electrically conductive spring comprises a cantilevered leaf spring.

8. The portable electronic device according to claim 1 wherein said at least one rotation sensor comprises at least one magnetic roller and a Hall sensor associated therewith.

9. The portable electronic device according to claim 8 wherein said at least one rotation sensor comprises four magnetic rollers and a respective Hall sensor associated with each magnetic roller.

10. The portable electronic device according to claim 1 further comprising electronic circuitry carried by said portable housing and connected to said battery and said trackball, said electronic circuitry being switchable from a sleep mode to an active mode based upon operation of said trackball in a non-random pattern and not switching from the sleep mode to the active mode based upon operation of said trackball in a random pattern.

11. The portable electronic device according to claim 10 wherein the non-random pattern corresponds to manipulation of said pointing device at a uniform speed and in a uniform direction.

12. The portable electronic device according to claim 1 wherein said trackball is exposed on an outer surface of said portable housing.

13. An electronic device comprising:
a portable housing;
a battery carried by said portable housing;
a circuit board carried by said portable housing; and
a trackball carried by said portable housing and said circuit board for permitting user pointing, and comprising
a frame,
a ball mounted by said frame to permit user rotation and displacement of said ball,
at least one rotation sensor cooperating with said ball, and comprising a magnetic roller and a Hall sensor associated therewith, and
a power control switch operatively connected between said ball and said circuit board, comprising at least one electrically conductive spring for biasing said ball outwardly from said circuit board, and responsive to displacement of said ball for selectively powering said at least one rotation sensor from said battery.

14. The portable electronic device according to claim 13 wherein said at least one electrically conductive spring comprises a first end electrically connected to said circuit board, and a second end being movable and defining a first contact of said power control switch.

15. The portable electronic device according to claim 14 further comprising a selection switch also responsive to displacement of said ball for permitting user selection; and wherein said selection switch comprises a deformable electrically conductive dome carried by said circuit board and defining a second contact of said power control switch.

16. The portable electronic device according to claim 13 wherein said at least one electrically conductive spring comprises a pair of electrically conductive springs, each having first ends electrically connected to said circuit board and second ends being movable together and defining first and second contacts for said power control switch.

17. The portable electronic device according to claim 13 wherein said at least one rotation sensor comprises four magnetic rollers and a respective Hall sensor associated with each magnetic roller.

18. A method of power management for a portable electronic device comprising a portable housing, a battery and trackball carried by the portable housing for permitting user pointing, the trackball comprising a frame, a ball mounted by the frame to permit user rotation and displacement of the ball, and at least one rotation sensor cooperating with the ball, the method comprising selectively powering the at least one rotation sensor from the battery in response to displacement of the ball.

19. The method according to claim 18 wherein the portable electronic device further comprises a circuit board carried by the portable housing and mounting the trackball; and wherein selectively powering comprises providing a power control switch operatively connected between the ball and the circuit board.

20. The method according to claim 19 wherein providing a power control switch comprises providing at least one electrically conductive spring for biasing the ball outwardly from the circuit board.

21. The method according to claim 20 wherein the at least one electrically conductive spring comprises a first end electrically connected to the circuit board, and a second end being movable and defining a first contact of the power control switch.

22. The method according to claim 18 wherein said at least one rotation sensor comprises at least one magnetic roller and a Hall sensor associated therewith.

23. The method according to claim 18 wherein said at least one rotation sensor comprises four magnetic rollers and a respective Hall sensor associated with each magnetic roller.

24. The method according to claim 18 wherein the portable electronic device further comprises electronic circuitry carried by the portable housing and connected to the battery and the trackball, and the method further comprising:
switching the electronic circuitry from a sleep mode to an active mode based upon operation of the pointing device in a non-random pattern; and
not switching the electronic circuitry from the sleep mode to the active mode based upon operation of the pointing device in a random pattern.

25. The method according to claim 18 wherein the trackball is exposed on an outer surface of the portable housing.
